(19) United States
(12) Patent Application Publication
(10) Pub. No.: US 2022/0332058 A1
(43) Pub. Date: Oct. 20, 2022

(54) METHOD FOR CHECKING, AND DEVICE FOR MEASURING, COMPONENTS OF A PIPE PRIOR TO WELDING

(71) Applicant: GRTGAZ, BOIS-COLOMBES Cedex (FR)

(72) Inventors: Pascal AUSSANT, Cergy-le-Haut (FR); Dominique GUEUGNAUT, Paris (FR)

(21) Appl. No.: 17/753,671

(22) PCT Filed: Sep. 10, 2020
(86) PCT No.: PCT/EP2020/075282

§ 371 Date: Mar. 10, 2022

(30) Foreign Application Priority Data
Sep. 12, 2019 (FR) FR1910096

(51) Int. Cl. B29C 65/00; B29C 65/02; F16L 47/03; G01N 21/954

(52) U.S. Cl. CPC B29C 66/95; B29C 66/02245; B29C 66/532; B29C 66/91221; B29C 66/73921; B29C 66/73161; B29C 65/02; F16L 47/03; G01N 21/954; B29L 2023/22

(57) ABSTRACT

The invention relates to a method for checking, prior to welding, two components made of polymer material, the method comprising a step of determining respective values relating to the roughness of the components, a step of determining respective values relating to the cleanliness of the components, a step of determining respective values relating to the temperature of the components and automated means for halting progression to a subsequent method step should the predetermined conditions not be met.

### FIELD OF THE INVENTION

The invention relates to the field of gas distribution pipes made of polymer material. More precisely, the invention relates to the welding of several junctions of these pipes.

### BACKGROUND OF THE INVENTION

Over 200 000 junctions are currently made every year on the national gas distribution network in France. Most of these junctions are made automatically using robots, according to technologies known in the state of the art, for example butt welding or electrofusion welding.

Patent FR 2 572 326 describes welding robots capable of operating automatically by integrating an electronic module which manages the various welding phases.

However, such robots and the methods implemented cannot guarantee junction welds that are both robust and durable throughout the lifetime of the pipe, since some of the steps could have a welding quality fault, in particular, at the first stage, caused by scraping and cleaning the components to be welded. The scraping and cleaning steps are required to eliminate a chemical barrier which prevents interdiffusion of the macromolecules. Such disadvantages generate high costs to detect leaks, as well as initial excavation costs. These costs are then followed by others, which are just as high, to repair the leaks when they have been identified.

### OBJECT AND SUMMARY OF THE INVENTION

The invention aims in particular to significantly reduce these costs whose root cause is poor automatic welding of the junctions.

Thus, the invention relates to a method for checking, prior to welding, a tube made of polymer material and an accessory made of polymer material, which comprises the following steps in the following order:

a) determining respective values relating to the roughness of the tube and of the accessory,
b) if at least one of the following conditions is not met:
a predetermined condition between the value relating to the roughness of the tube and a roughness threshold of the tube,
a predetermined condition between the value relating to the roughness of the accessory and a roughness threshold of the accessory,
   automated means prevent the transition to step c),
   c) determining respective values relating to the cleanliness of the tube and of the accessory,
   d) if at least one of the following conditions is not met:
a predetermined condition between the value relating to the cleanliness of the tube and a cleanliness threshold of the tube,
a predetermined condition between the value relating to the cleanliness of the accessory and a cleanliness threshold of the accessory,
   the automated means prevent the transition to step e), and
   e) determining respective values relating to a temperature of the tube and of the accessory,
   f) if at least one of the following conditions is not met:
a predetermined condition between a value relating to a temperature of the tube and a temperature range,
a predetermined condition between a value relating to a temperature of the accessory and the temperature range,
   the automated means prevent the transition to step g),
   g) assembling the accessory on the tube.

Thus, the method of the invention can be used to check the surface condition of each of the components to be welded in order to obtain a pipe produced by welding a tube and an accessory made of polymer material of better quality and which will reduce the need for subsequent repairs caused by a poor quality weld between these two components. The method of the invention can be used to check the surface condition of the components to be welded prior to the welding step. More precisely, the method of the invention can be used to guarantee that the method is blocked at a given step through the use of automated means, until the predetermined conditions justifying a transition to the next step are met. Thus, the transition to the next step cannot be forced. Consequently, the transition from one welding step to the next in the method of the invention can be reliably prevented, which guarantees the good quality of the final weld.

Thus, the transition to the welding step is blocked indirectly, until all the surface conditions of the components to be welded meet the prerequisites for a high-quality and durable weld.

The step f) of comparing values relating to a temperature of the tube and a temperature of the accessory provides additional data for the implementation of a welding step, which contributes to producing a high-quality and durable weld. This comparison step takes place after step d) and therefore only if the predetermined conditions of steps b) and d) have been met and if the transition to step e) of determining respective values relating to the temperature of the tube and of the accessory has been authorized and performed.

Thus, welding is prevented by the automated means until the tube and the accessory have the right temperature for welding. To do this, the values relating to the temperature are respectively compared with a reference temperature range for implementation of the welding step. When one of these measured values is outside the temperature range, the transition to the assembly step g) is blocked by the automated means which can even, in some extreme cases, indicate that the right temperature of the tube or of the accessory cannot be reached for welding. The temperature range is defined as being the range inside which the values relating to the temperatures of the tube and of the accessory are acceptable for the welding step. This temperature range may change depending on changes made to standards governing component welding techniques. Such standards are generally specific to a country. Consequently, the temperature range may vary from one country to another. For example, the temperature range in France may extend from −5° C. to +35° C.

The automated means may be any means used to prevent the transition to the next step. For example, the automated means may comprise a tablet or a computer containing software programmed to prevent the transition to the next step if one of the predetermined conditions required to validate this transition is not met. The automated means may be, for example, programmed to authorize unblocking of the means required to perform step c) only if the predetermined conditions of step b) are both met.

The pipe components to be assembled may correspond to any type of junction, that can be welded two at a time, known to those skilled in the art, provided that one of the two components is a tube. For example, these components may be tubes, sleeves or connection saddles. Thus, the predetermined roughness and cleanliness thresholds can be specific to one or more types of junction.

The polymer material used to make these pipe components may be any material known to those skilled in the art allowing these two components to be welded together in order to form a gas pipe network, in particular using butt or electrofusion welding technologies. Thermoplastic materials are suitable polymer materials. Polyethylene (PE) and polyolefins are especially suitable polymer materials.

Advantageously, the method comprises a step of scraping the tube prior to step a).

Advantageously, step a) comprises producing a representation of the roughness of the tube and of the accessory.

The representation of the roughness of the components to be welded can be produced in view of the requirements regarding scraping the surfaces of the components to be welded. This representation can be produced using known techniques such as laser profilometry. These techniques are non-destructive and do not damage the components and therefore the pipe as a whole. This representation may consist of a 2D or 3D graphical representation produced using measurements of data relating to the roughness of the surfaces concerned.

This representation is then analyzed to determine one or more values representative of the roughness of each component. These values may be parameters relating to the roughness of these surfaces, for example the total roughness (Rt), the mean deviation (Ra), the mean roughness, the maximum peak (Rp), the maximum trough (Rc), the period of the main groove, the developed area of the portion of the component to be welded, the structure anisotropy, etc.

Then, the determined value(s) relating to the roughness of the tube and the determined value(s) relating to the roughness of the accessory are compared respectively with one or more roughness thresholds of the tube and one or more roughness thresholds of the accessory which are representative of a roughness of the tube and a roughness of the accessory roughness that are acceptable for welding. If these comparisons indicate that the roughness of the tube or of the accessory do not meet the criteria required to produce a durable weld, the transition to step c) is blocked by the automated means.

Advantageously, when the predetermined condition between the value relating to the roughness of the tube and the roughness threshold of the tube is not met, the tube is scraped on a portion not previously scraped, then step a) is repeated, and when the predetermined condition between the value relating to the roughness of the accessory and the roughness threshold of the accessory is not met, the accessory is replaced, then step a) is repeated.

Performing a step of scraping the tube on a portion not previously scraped makes it possible to weld the tube and the accessory together without having to replace the tube, while checking the tube roughness so that it is acceptable in view of the roughness required to produce a good final weld.

Advantageously, step c) comprises producing a representation of the cleanliness of the tube and of the accessory.

The representation of the cleanliness of the components to be welded can be produced in view of the requirements regarding cleaning the surfaces of the components to be welded. This representation can be produced using known techniques such as UV fluorescence, infrared spectrometry and light scattering. These techniques are non-destructive and do not damage the components and therefore the pipe as a whole. This representation may consist of a 2D or 3D graphical representation produced using measurements of data relating to the cleanliness of the surfaces concerned.

This representation is then analyzed to determine one or more values representative of the cleanliness of each component. Such values may be parameters relating to the degree of pollution of the surface condition, for example.

Then, the determined value(s) of the cleanliness of the tube and the determined value(s) of the cleanliness of the accessory are compared respectively with one or more cleanliness thresholds of the tube and one or more cleanliness thresholds of the accessory which are representative of a cleanliness of the tube and of a cleanliness of the accessory that are acceptable for welding. If these comparisons indicate that the cleanliness of the tube or of the accessory do not meet the cleanliness requirements to produce a durable weld, the transition to step e) of comparing values relating to the temperature of the components is blocked by the automated means.

Advantageously, when the predetermined condition between the value relating to the cleanliness of the tube and the cleanliness threshold of the tube is not met, a step of cleaning the tube is performed, then step c) is repeated, and when the predetermined condition between the value relating to the cleanliness of the accessory and the cleanliness threshold of the accessory is not met, a step of cleaning the accessory is performed, then step c) is repeated.

Performing a step of cleaning the tube or a step of cleaning the accessory improves the quality of the cleanliness of the surfaces of the components to be welded, when the cleanliness of each of these components is not acceptable for an acceptable weld.

Advantageously, at least one of the predetermined conditions of step b) is that the value relating to the roughness of the tube or the value relating to the roughness of the accessory is less, respectively, than the roughness threshold of the tube or the roughness threshold of the accessory, or at least one of the predetermined conditions of step b) is that the value relating to the roughness of the tube or the value relating to the roughness of the accessory is greater, respectively, than the roughness threshold of the tube or the roughness threshold of the accessory.

Advantageously, the roughness threshold of the tube is a first roughness threshold of the tube, the automated means prevent the transition to step c) if the value relating to the roughness of the tube does not lie within a range formed by the first roughness threshold of the tube and a second roughness threshold of the tube, different from the first roughness threshold of the tube.

Advantageously, the roughness threshold of the accessory is a first roughness threshold of the accessory, the automated means prevent the transition to step c) if the value relating to the roughness of the accessory does not lie within a range formed by the first roughness threshold of the accessory and a second roughness threshold of the accessory, different from the first roughness threshold of the accessory.

Advantageously, at least one of the predetermined conditions of step d) is that the value relating to the cleanliness of the tube or the value relating to the cleanliness of the accessory is less, respectively, than the cleanliness threshold of the tube or the cleanliness threshold of the accessory, or at least one of the predetermined conditions of step d) is that the value relating to the cleanliness of the tube or the value relating to the cleanliness of the accessory is greater, respectively, than the cleanliness threshold of the tube or the cleanliness threshold of the accessory.

Advantageously, the cleanliness threshold of the tube is a first cleanliness threshold of the tube, the automated means prevent the transition to step e) if the value relating to the cleanliness of the tube does not lie within a range formed by the first cleanliness threshold of the tube and a second cleanliness threshold of the tube, different from the first cleanliness threshold of the tube.

Advantageously, the cleanliness threshold of the accessory is a first cleanliness threshold of the accessory, the automated means prevent the transition to step e) if the value relating to the cleanliness of the accessory does not lie within a range formed by the first cleanliness threshold of the accessory and a second cleanliness threshold of the accessory, different from the first cleanliness threshold of the accessory.

Advantageously, the method further comprises a step of determining a quantity of energy required for a weld depending on the value relating to a temperature of the tube and the value relating to a temperature of the accessory.

Thus, the values relating to a temperature of the tube and of the accessory taken into account for the comparison step e) can be used to determine the quantity of energy delivered by the welding robot. This quantity of energy is corrected relative to a reference quantity, depending on the measured values relating to the temperature of the tube and of the accessory. Thus, the energy applied corresponds to the optimum energy for this weld, which guarantees its durability.

Advantageously, the method is automated.

Thus, the method can be implemented, for example, using a set of controls (a robot) able to execute all the steps of the checking method. Such automation can be used to increase the rate at which the components to be welded are checked and to automatically launch all the steps of the checking method of the invention.

The invention also relates to a method for welding a tube made of polymer material and an accessory made of polymer material to form a gas pipe.

The invention also relates to a program comprising code instructions that can control the implementation of a method of the invention when it is executed on a computer.

The invention also relates to a storage medium comprising a stored program according to the invention.

The invention also relates to a method for making a program according to the invention available on a telecommunication network in order to download it.

The invention also relates to a device for checking, prior to welding, a tube made of polymer material and an accessory made of polymer material, characterized in that it comprises:
first means designed to determine respective values relating to the roughness of the tube and of the accessory,
second means designed to determine respective values relating to the cleanliness of the tube and of the accessory,
automated means designed to prevent the use of the second means if a predetermined condition between the value relating to the roughness of the tube and a roughness threshold of the tube is not met, or if a predetermined condition between the value relating to the roughness of the accessory and an roughness threshold of the accessory is not met,
third means designed to measure values relating to the temperature of the tube and of the accessory,
the automated means being designed to prevent the use of the third means if a predetermined condition between the value relating to the cleanliness of the tube and a cleanliness threshold of the tube is not met, or if a predetermined condition between the value relating to the cleanliness of the accessory and a cleanliness threshold of the accessory is not met,
means for assembling the accessory on the tube,
the automated means being designed to prevent the use of the assembly means if a predetermined condition between the value relating to the temperature of the tube and a temperature range is not met, or if a predetermined condition between the value relating to the temperature of the accessory and the temperature range is not met.

### BRIEF DESCRIPTION OF THE FIGURES

We will now describe several embodiments of the invention, as examples and referring to the attached drawings in which:

FIG. 1 is a diagram illustrating elements of a device for checking, prior to welding, a tube made of polymer material and an accessory made of polymer material according to a first embodiment and a second embodiment,

FIG. 2 is a diagram illustrating elements of a device for checking, prior to welding, a tube made of polymer material and an accessory made of polymer material according to a third embodiment and a fourth embodiment,

FIG. 3 is a flowchart showing various steps of the checking method according to a first embodiment,

FIG. 4 is a flowchart showing various steps of the method according to a second embodiment, and

FIG. 5 is a flowchart showing various steps of the welding method of the invention according to a first embodiment,

FIG. 6 is an example showing the surface condition of a component.

### DETAILED DESCRIPTION

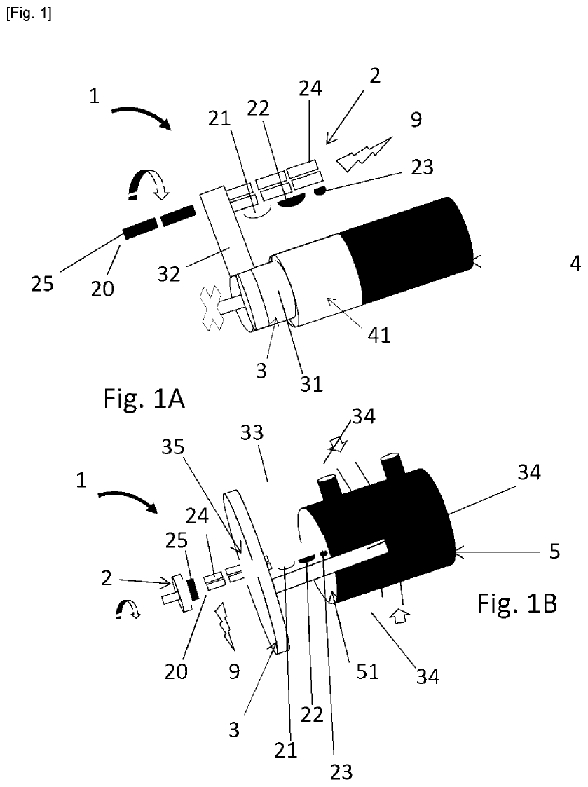

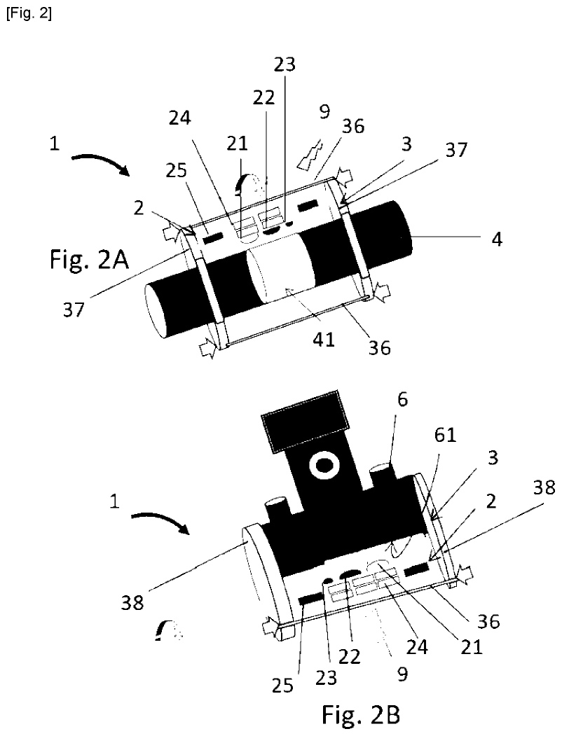

FIGS. 1A to 2B show elements of devices 1 for checking, prior to welding, a tube 4 made of polymer material and an accessory 5 or 6 made of polymer material, according to four different embodiments.

In all these different embodiments, the device 1 for checking, prior to welding, comprises a measurement member 2 and a support 3 for the measurement member 2 comprising means for assembly to the component 4, 5 or 6. These components 4, 5 or 6 have a tubular, cylindrical, profiled shape of circular cross-section.

The measurement member 2 comprises a main body 20, a laser profilometry type sensor 21, a UV fluorescence type sensor 22, an infrared thermometer 23, transmitters 24 and at least one wireless energy source 25 which supplies energy to the four above-mentioned elements.

The main body 20 may consist of a strip in order to easily arrange the various elements of the measurement member 2.

As shown on FIG. 1A, the device 1 for checking, prior to welding, can be used in particular to measure data relating to the surface condition (roughness and cleanliness) of an outer portion 41 of a hollow tube 4 whose end is intended to be welded in the half-socket of the sleeve 5 of FIG. 1B. The support 3 thus comprises a ferrule 31 adapted to be positioned in the tube 4 and an arm 32 which extends from the ferrule 31 and which can be used to offset the measurement member 2 relative to the portion 41 of the tube 4. To take the measurements, the main body 20 is adapted to be moved in translation relative to the tube 4, in a direction parallel to the longitudinal axis of the tube 4. The main body 20 is also adapted to be moved in rotation relative to the tube 4, about this longitudinal axis. Thus, the laser profilometry type sensor 21 and the UV fluorescence type sensor 22 can scan the entire portion 41 of the tube 4. These two sensors can be used to supply data relating to the surface condition (roughness and cleanliness) of the portion 41 of the tube 4. These data are transmitted to a data acquisition unit 9 by the transmitters 24. The data acquisition unit 9 is adapted to process and analyze the data it receives.

In order to check the surface condition of the inner portion 51 of the sleeve 5, the support 3 of the device 1 according to a second embodiment comprises a clamping frame 33. This clamping frame 33 comprises lugs 34 which each exert a compression force on the outer surface of the sleeve 5, thus maintaining the support 3 in a fixed position relative to the sleeve 5. The support 3 also comprises a central part 35 in which an opening (not shown) is formed. This opening can be used to position at least partially the measurement member 2 in the half-socket of the sleeve 5. Through this opening, the main body 20 of the measurement member 2 can be moved in translation relative to the sleeve 5, in a direction parallel to the longitudinal axis of the sleeve 5. Thus, the measurement member 2 can be inserted deeper inside the sleeve 5. The main body 20 can also be moved in rotation relative to the sleeve 5, about this longitudinal axis. This combination of longitudinal and rotational movements allows the laser profilometry type sensor 21 and the UV fluorescence type sensor 22 to scan the entire inner portion 51 of the sleeve 5. By measuring the inner surface condition of the sleeve 5, it is possible in particular to determine anomalies present on the heating mat (e.g. wires moved, cavities, etc.).

A third embodiment shown on FIG. 2A can be used to check the surface condition of a portion 41 of a tube 4, intended to be welded with a portion (not shown) of a connection saddle 6.

To do this, the support 3 comprises two hoops 37 forming circular housings and adapted to encircle the tube 4. These two hoops 37 are connected to each other by means of two clamping rods 36 used to hold the entire support 3 and attach it to the tube 4. The two circular housings 37 each have an opening (not shown) used to place the measurement member 2 in an offset position relative to the portion 41 of the tube 4 and opposite this portion. Like the first two embodiments described, the main body 20 of the measurement member 2 can be moved in translation and in rotation so that the laser profilometry type sensor 21 and the UV fluorescence type sensor 22 can scan the entire portion 41 of the tube 4.

The connection saddle 6 intended to be welded with the tube 4 shown on FIG. 2B is a hollow component of semi-cylindrical shape. In order to check the surface condition of the inner portion 61 of the connection saddle 6, the support 3 of the checking device 1 according to the fourth embodiment comprises two contact elements 38. These contact elements 38 are adapted to be positioned each on one of the ends of the connection saddle 6. They are connected to each other by means of a clamping rod 36 used to attach the entire support 3 and hold it in a fixed position relative to the connection saddle 6. The two contact elements 38 each have an opening (not shown) used to place the measurement member 2 in an offset position relative to the inner surface of the connection saddle 6. As for the preceding embodiments, the main body 20 of the measurement member 2 can be moved in translation and in rotation so that the laser profilometry type sensor 21 and the UV fluorescence type sensor 22 can scan the entire portion to be welded of the connection saddle 6. By measuring the inner surface condition of the connection saddle 6, it is possible in particular to determine anomalies present on the heating mat (e.g. wires moved, cavities, etc.).

The device 1 comprises automated means for implementing the checking method of the invention. These automated means include the data acquisition unit to which the data measured by the various sensors of the device 1 are transmitted. The device 1 for checking, prior to welding, can be a robot allowing automated implementation of the checking method.

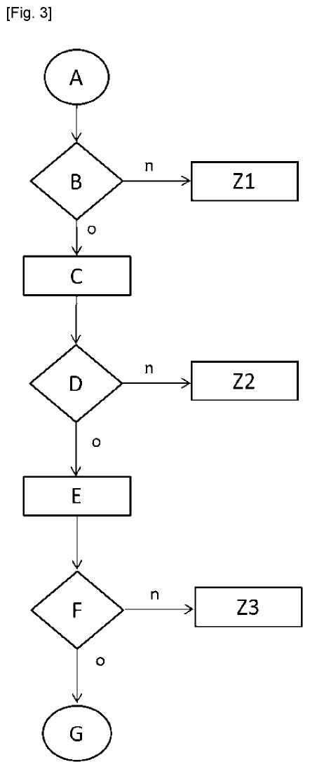

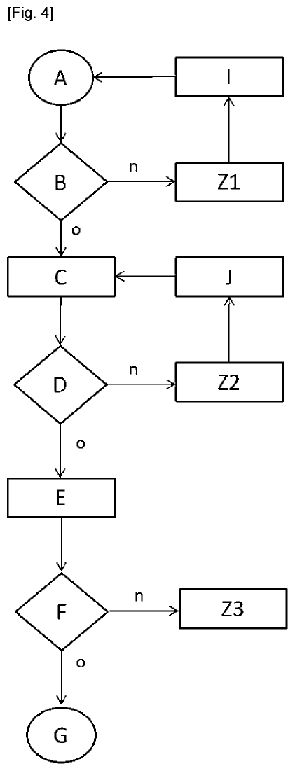

FIGS. 3 and 4 show two embodiments of a method for checking, prior to welding, a tube 4 made of polymer material and an accessory 5 or 6 made of polymer material.

The checking method of the invention according to the first embodiment (FIG. 3) starts with a first step A of determining the respective values relating to the roughness of the tube 4 and of the accessory 5 or 6 to be welded, in this case to form a gas pipe. Such a method is also adapted for checking, prior to welding, a pipe intended to receive substances other than gas and whose transport is compatible with the polymer material of the tube 4 and of the accessory 5 or 6. Such a substance may be for example a fluid, such as water.

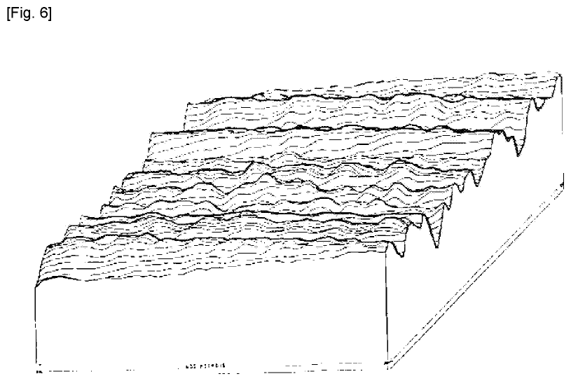

In the embodiment shown on FIG. 3, the step A comprises producing a representation of the roughness of the tube 4 and of the accessory 5 or 6. This production step is implemented using one or more sensors (for example one or more laser roughness meters 21 of the device 1) taking data measurements relating to the roughness of the tube 4 and of the accessory 5 or 6 to be welded. The measured data are then processed by computer via a data acquisition unit 9 integrated in the automated means, in order to produce said representation, of which a 3D graphical representation example is shown on FIG. 6.

After producing the representation of the roughness of the tube 4 and of the accessory 5 or 6, the roughness is analyzed to determine the respective values relating to the roughness of the tube 4 and of the accessory 5 or 6. Such values may be taken from the following non-exhaustive list: the total roughness (Rt), the mean deviation (Ra), the mean roughness, the maximum peak (Rp), the maximum trough (Rc), the period of the main groove, the developed area of the portion of the component to be welded, the structure anisotropy, the striation in the scraping direction.

This first step A is followed by a comparison step B during which the respective values relating to the roughness of the tube 4 and of the accessory 5 or 6 are compared respectively with a roughness threshold of the tube 4 and a roughness threshold of the accessory. This can be used to determine if a predetermined condition between the value relating to the roughness of the tube 4 and a roughness threshold of the tube 4 and if a predetermined condition between the value relating to the roughness of the accessory 5 or 6 and a roughness threshold of the accessory 5 or 6 are met. If they are met, the transition to step C is authorized by the automated means. However, if at least one of the two conditions of step B is not met, then these automated means prevent the transition to step C (step Z1). A manual operator cannot bypass blocking of the method by the automated means. The automated means may comprise a tablet, a computer or a smartphone containing software programmed to prevent the transition to step C if one of the predetermined conditions required to validate this transition is not met. The automated means may be, for example, programmed to authorize unblocking of the means required to perform step C only if the predetermined conditions of step B are both met.

Step C is a step of determining respective values relating to the cleanliness of the tube 4 and of the accessory.

According to this first embodiment, step C comprises a step of producing a representation of the cleanliness of the tube 4 and of the accessory. Such a step can be implemented using one or more UV fluorescence type sensors 21 of the device 1 taking data measurements relating to the cleanliness of the surface of the tube 4 and of the accessory 5 or 6 to be welded. As a replacement for or in addition to the UV fluorescence type sensors 21, the device 1 may also comprise one or more infrared spectrometers which can also be used to measure data relating to the cleanliness of the surface of the tube 4 and of the accessory 5 or 6 to be welded. The measured data are then processed by computer via the data acquisition unit 9, in order to produce said representation.

After producing the representation of the cleanliness of the tube 4 and of the accessory 5 or 6, the cleanliness is analyzed to determine the respective values relating to the cleanliness of the tube 4 and of the accessory 5 or 6. Such values may relate to the degree of pollution of the surface condition, such as the quantity of grease or the quantity of dust.

Step C is followed by a comparison step D during which the respective values relating to the cleanliness of the tube 4 and of the accessory 5 or 6 are compared respectively with a cleanliness threshold of the tube 4 and a cleanliness threshold of the accessory 5 or 6. This can be used to check if a predetermined condition between the value relating to the cleanliness of the tube 4 and a cleanliness threshold of the tube 4 and if a predetermined condition between the value relating to the cleanliness of the accessory 5 or 6 and a cleanliness threshold of the accessory 5 or 6 are met. If they are met, the transition to step E of measuring values relating to the temperature of the tube 4 and of the accessory 5 or 6 is authorized by the automated means. Such a temperature measurement is taken using the infrared thermometer 23 of the measurement member 2 of the device 1.

However, if at least one of the two conditions of step D is not met, then the automated means prevent the transition to step E (step Z2). Once again, a manual operator cannot bypass blocking of the method by the automated means. At this stage of the method, blocking of the method can be carried out in different ways. For example, the automated means can prevent unblocking of the means of the device 1 in order to measure the values of the temperature of the tube 4 and of the accessory 5 or 6. Thus, this blocking by the automated means cannot be bypassed.

Step E is followed by a comparison step F during which the respective values relating to the temperature of the tube 4 and of the accessory 5 or 6 are compared with a temperature range. If the measured values relating to the temperature of the tube 4 and of the accessory 5 or 6 are located outside the temperature range, the automated means prevent the transition to step F of assembling the accessory 5 or 6 on the tube 4 (step Z3). Inversely, if these values relating to the temperature are located within the temperature range, the transition to step G of assembling the accessory 5 or 6 on the tube 4 is authorized by the automated means and an operator assembles the accessory 5 or 6 on the tube 4 using the assembly means (not shown) of the checking device 1.

When all the predetermined conditions of steps B, D and F are met and assembly step G has been performed using assembly means (not shown) or manually, the checking method according to this first embodiment is finished and the tube 4 and the accessory 5 or 6 can be welded together.

The method according to the second embodiment of the invention shares the steps of the method according to the first embodiment. It further comprises a step I of scraping a portion not previously scraped of the tube 4 and/or of replacing the accessory 5 or 6 which are implemented when the automated means have prevented the transition to step C (step Z1). The alternative of step I according to which the tube 4 is scraped on a portion not previously scraped is implemented if the predetermined condition between the value relating to the roughness of the tube 4 and a roughness threshold of the tube 4 is not met. Step A is then repeated to determine if the roughness of the newly scraped portion of the tube 4 meets the necessary requirements regarding scraping to produce a high-quality and durable weld. If this is still not the case, the automated means once again prevent the transition to step C (step Z1) and the checking loop is repeated. It is therefore possible to efficiently guarantee that the roughness of the tube 4 is suitable for a high-quality weld, without having to replace the tube 4, which is a complex and expensive operation.

The alternative of step I according to which the accessory 5 or 6 is replaced is implemented if the predetermined condition between the value relating to the roughness of the accessory 5 or 6 and a roughness threshold of the accessory 5 or 6 is not met. In this case, the accessory 5 or 6 is replaced and steps A and B are repeated. As previously, if this condition is still not met during the new step B, the automated means once again prevent the transition to step C (step Z1) and the checking loop is repeated.

The method according to the second embodiment also comprises a second checking loop comprising steps C, D Z2 and J. When the automated means block the transition to step E, a step J is in fact implemented. Step J comprises cleaning the surface of the tube 4 and/or of the accessory 5 or 6 depending on the predetermined condition of step D which is not met. Like the first checking loop, step C is implemented again at the end of step J, then the comparison step D is implemented. If at least one of the predetermined conditions is still not met, the automated means block the transition to step E of measuring values relating to the temperature of the tube 4 and of the accessory 5, 6 and the second checking loop is implemented again.

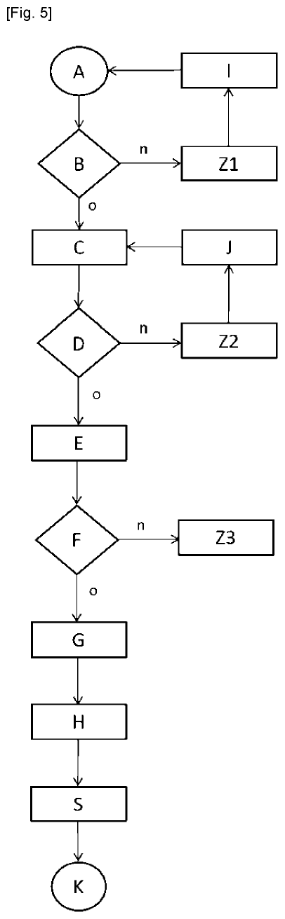

FIG. 5 shows an embodiment of a method for welding a tube 4 made of polymer material and an accessory 5 or 6 made of polymer material to form a gas pipe, wherein the checking method according to the second embodiment is implemented.

This welding method includes all the steps mentioned in the description of the checking method according to the second embodiment.

In a variant, not shown, of the welding method of the invention, a third checking loop is performed between steps E, F and Z3. More precisely, a second measuring step E is implemented after step Z3 to determine a new measurement relating to the temperature of the tube 4 and of the accessory 5 or 6. This second measurement step is implemented after a certain period of time, to allow the temperature of the tube 4 and of the accessory 5 or 6 to reach ambient temperature. Step F is then implemented again and if one of the second measured values relating to the temperature of the tube 4 and of the accessory 5 or 6 is still located outside the temperature range, the automated means once again prevent the transition to step G. In addition, if one of the measured values relating to the temperature of the tube 4 and of the accessory 5 or 6 is too far from one of the limits of the temperature range, preventing the tube 4 or the accessory 5 or 6 from reaching an acceptable temperature for a welding step, the method can be stopped by the automated means.

When the result of step F of comparing the measured values relating to the temperature in step E is positive, in other words these measured values lie within the temperature range, the automated means allow the transition to step G of the method.

In step H, the quantity of energy to be supplied to the welding robot to weld together the tube 4 and the accessory 5 or 6 is determined, depending on the temperature values measured in step E. Depending on these measured temperature values, the time and the heating power are adapted by the robot to guarantee a durable assembly. This assembly is produced during the implementation of the welding step S.

After performing the welding step (step S), a step of producing a report (step K) is performed to issue a welding and traceability report for the welded components in order to record the two welded components and the welding conditions.

The welding method of the invention may also comprise steps of scraping the tube 4 prior to step A. These prior scraping steps are performed to prepare the surface of the tube 4 for the welding step in view of the scraping requirements of the tube 4. This method may also comprise steps of cleaning the tube 4 and the accessory 5 or 6 prior to step C. These prior cleaning steps are performed to prepare the surface of these components for the welding step in view of the cleanliness requirements of each of these components.

The automated means of the device are designed to assist the operator when implementing one, at least, of the methods described above. They are programmed in particular to allow the transition to a particular next step as indicated or, on the contrary, to prevent this transition if the predetermined condition is not met. These means could control all or some of the steps of the method of the invention. The device therefore comprises a computer program on a storage medium comprising code instructions that can control these steps when it is executed on the device.

Steps G and H of the embodiment of the welding method of FIG. 5 can be implemented in the opposite order to that described previously. These two steps can also be implemented simultaneously.

### LIST OF REFERENCES

1: measurement device
2: measurement member
3: support for the measurement member
4: tube made of polymer material
5: sleeve made of polymer material
6: connection saddle made of polymer material
9: data acquisition unit
21: main body
21: laser profilometry type sensor
22: UV fluorescence type sensor
23: infrared thermometer
24: transmitter
25: energy source
31: ferrule
32: arm
33: clamping frame
34: clamping lugs
35: central part
36: clamping rod
37: hoop
38: contact element
41: portion of the tube surface to be welded
51: portion of the sleeve surface to be welded
61: portion of the saddle surface to be welded
step A: determining respective values relating to the roughness of the tube and of the accessory
step B: comparing the roughness of the tube and of the accessory
step C: determining respective values relating to the cleanliness of the tube and of the accessory
step D: comparing the cleanliness of the tube and of the accessory
step D: measuring respective values relating to the temperature of the tube and of the accessory
step F: comparing the values relating to the temperature of the tube and of the accessory
step G: assembling the accessory on the tube
step H: determining a quantity of energy required for the weld
step I: scraping a portion not previously scraped of the tube and/or replacing the accessory
step J: cleaning the surface of the tube and/or of the accessory
step K: issuing a welding and traceability report
step S: welding
step Z1, Z2, Z3: blocking of the method by the automated means

1. Method for checking, prior to welding, a tube made of polymer material and an accessory made of polymer material, wherein it comprises the following steps in the following order:
a) determining respective values relating to the roughness of the tube and of the accessory,
b) if at least one of the following conditions is not met:
a predetermined condition between the value relating to the roughness of the tube and a roughness threshold of the tube,
a predetermined condition between the value relating to the roughness of the accessory and a roughness threshold of the accessory, automated means prevent the transition to step c),
c) determining respective values relating to the cleanliness of the tube and of the accessory,
d) if at least one of the following conditions is not met:
a predetermined condition between the value relating to the cleanliness of the tube and a cleanliness threshold of the tube,
a predetermined condition between the value relating to the cleanliness of the accessory and a cleanliness threshold of the accessory, the automated means prevent the transition to step e), and
e) determining respective values relating to a temperature of the tube and of the accessory,
f) if at least one of the following conditions is not met:
a predetermined condition between a value relating to a temperature of the tube and a temperature range,
a predetermined condition between a value relating to a temperature of the accessory and the temperature range,
the automated means prevent the transition to step g),
g) assembling the accessory on the tube.

2. Method according to claim 1, comprising a step of scraping the tube prior to step a).

3. Method according to claim 1 or 2, wherein step a) comprises producing a representation of the roughness of the tube and of the accessory.

4. Method according to claim 1, wherein:
when the predetermined condition between the value relating to the roughness of the tube and the roughness threshold of the tube is not met, the tube is scraped on a portion not previously scraped, then step a) is repeated, and
when the predetermined condition between the value relating to the roughness of the accessory and the roughness threshold of the accessory is not met, the accessory is replaced, then step a) is repeated.

5. Method according to claim 1, wherein step c) comprises producing a representation of the cleanliness of the tube and of the accessory.

6. Method according to claim 1, wherein:
when the predetermined condition between the value relating to the cleanliness of the tube and the cleanliness threshold of the tube is not met, a step of cleaning the tube is performed, then step c) is repeated, and
when the predetermined condition between the value relating to the cleanliness of the accessory and the cleanliness threshold of the accessory is not met, a step of cleaning the accessory is performed, then step c) is repeated.

7. Method according to claim 1, wherein at least one of the predetermined conditions of step b) is that the value relating to the roughness of the tube or the value relating to the roughness of the accessory is less, respectively, than the roughness threshold of the tube or the roughness threshold of the accessory, or at least one of the predetermined conditions of step b) is that the value relating to the roughness of the tube or the value relating to the roughness of the accessory is greater, respectively, than the roughness threshold of the tube or the roughness threshold of the accessory.

8. Method according to claim 1, wherein the roughness threshold of the tube is a first roughness threshold of the tube, the automated means prevent the transition to step c) if the value relating to the roughness of the tube does not lie within a range formed by the first roughness threshold of the tube and a second roughness threshold of the tube, different from the first roughness threshold of the tube.

9. Method according to claim 1, wherein the roughness threshold of the accessory is a first roughness threshold of the accessory, the automated means prevent the transition to step c) if the value relating to the roughness of the accessory does not lie within a range formed by the first roughness threshold of the accessory and a second roughness threshold of the accessory, different from the first roughness threshold of the accessory.

10. Method according to claim 1, wherein at least one of the predetermined conditions of step d) is that the value relating to the cleanliness of the tube or the value relating to the cleanliness of the accessory is less, respectively, than the cleanliness threshold of the tube or the cleanliness threshold of the accessory, or at least one of the predetermined conditions of step d) is that the value relating to the cleanliness of the tube or the value relating to the cleanliness of the accessory is greater, respectively, than the cleanliness threshold of the tube or the cleanliness threshold of the accessory.

11. Method according to claim 1, wherein the cleanliness threshold of the tube being a first cleanliness threshold of the tube, the automated means prevent the transition to step e) if the value relating to the cleanliness of the tube does not lie within a range formed by the first cleanliness threshold of the tube and a second cleanliness threshold of the tube, different from the first cleanliness threshold of the tube.

12. Method according to claim 1, wherein the cleanliness threshold of the accessory being a first cleanliness threshold of the accessory, the automated means prevent the transition to step e) if the value relating to the cleanliness of the accessory does not lie within a range formed by the first cleanliness threshold of the accessory and a second cleanliness threshold of the accessory, different from the first cleanliness threshold of the accessory.

13. Method according to claim 1, further comprising a step of determining a quantity of energy required for a weld depending on the value relating to a temperature of the tube and the value relating to a temperature of the accessory.

14. Method according to claim 1, wherein the method is automated.

15. Method for welding a tube made of polymer material and an accessory made of polymer material to form a gas pipe, wherein the checking method according to claim 1 is implemented.

16. Program comprising code instructions that can control the implementation of a method according to claim 1 when it is executed on a computer.

17. Storage medium comprising a stored program according to claim 16.

18. Method for making a program according to claim 16 available on a telecommunication network in order to download it.

19. Device for checking, prior to welding, a tube made of polymer material and an accessory made of polymer material, wherein it comprises:
first means designed to determine respective values relating to the roughness of the tube and of the accessory,
second means designed to determine respective values relating to the cleanliness of the tube and of the accessory,
automated means designed to prevent the use of the second means if a predetermined condition between the value relating to the roughness of the tube and a roughness threshold of the tube is not met, or if a predetermined condition between the value relating to the roughness of the accessory and an roughness threshold of the accessory is not met,
third means designed to measure values relating to the temperature of the tube and of the accessory,
the automated means being designed to prevent the use of the third means if a predetermined condition between the value relating to the cleanliness of the tube and a cleanliness threshold of the tube is not met, or if a predetermined condition between the value relating to the cleanliness of the accessory and a cleanliness threshold of the accessory is not met,
means for assembling the accessory on the tube,
the automated means being designed to prevent the use of the assembly means if a predetermined condition between the value relating to the temperature of the tube and a temperature range is not met, or if a predetermined condition between the value relating to the temperature of the accessory and the temperature range is not met.
